(19) United States
(12) Patent Application Publication
(10) Pub. No.: US 2024/0308010 A1
(43) Pub. Date: Sep. 19, 2024

(54) SPINDLE POWER-ON DEVICE FOR MECHANICAL DISCHARGE COMPOUND MACHINE TOOL

(71) Applicant: Xinjiang University, Urumqi City (CN)

(72) Inventors: Jianping Zhou, Urumqi City (CN); Bingbing Wang, Urumqi City (CN); Caoyang Qin, Urumqi City (CN); Yu Ji, Urumqi City (CN); Wei Tang, Urumqi City (CN)

(21) Appl. No.: 18/413,593

(22) Filed: Jan. 16, 2024

(30) Foreign Application Priority Data
Mar. 14, 2023 (CN) 202310239423.8

(51) Int. Cl. B23Q 5/04; B23B 31/02

(52) U.S. Cl. CPC B23Q 5/043; B23B 31/025

(57) ABSTRACT

A spindle power-on device for a mechanical discharge compound machine tool mounted on a spindle, includes a copper bush, a gear plate, bevel gears, electric bush assemblies, a chuck housing, a supporting plate, a mounting plate and a power device.

### CROSS-REFERENCE TO RELATED APPLICATION

This patent application claims the benefit and priority of Chinese Patent Application No. 202310239423.8 filed with the China National Intellectual Property Administration on Mar. 14, 2023, the disclosure of which is incorporated by reference herein in its entirety as part of the present application.

### TECHNICAL FIELD

The present disclosure relates to the technical field of electric discharge machining, in particular to a spindle power-on device for a mechanical discharge compound machine tool.

### BACKGROUND

In efficient arc discharge, materials are corroded and removed by the instantaneous high temperature caused by the electric discharge between a cathode and an anode to realize efficient removal of various kinds of difficult-to-cut metal materials. Compared with traditional electric discharge machining, the machining efficiency is significantly increased. With more and more widespread use of electric discharge machining, the demand for electric discharge machine tools from manufacturers is increasing. However, at present, traditional machining machine tools are still the mainstay in the market, and the electric discharge machine tools are rare in manufacturers and expensive in cost. Aiming at this phenomenon, a spindle power-on device for a mechanical discharge compound machine tool is designed. The device can be directly mounted on an original machining machine tool, so that the machine tool can realize the function of electric discharge machining, fast power-on and power-off can be realized, and quick switching between electric discharge machining and machining is realized. The device is easy to manufacture and convenient to install, so that the transformation time is greatly shortened, the production efficiency is increased, the production cost is reduced, and the promotion and popularization of the electric discharge machining method is facilitated, realizing industrial upgrading.

### SUMMARY

Aiming at the above defects in the prior art, the present disclosure provides a spindle power-on device for a mechanical discharge compound machine tool.

In order to solve the technical problem, the technical solution proposed by the present disclosure is as follows.

A spindle power-on device for a mechanical discharge compound machine tool mounted on a spindle is provided, the spindle power-on device includes a copper bush, a gear plate, bevel gears, electric bush assemblies, a chuck housing, a supporting plate, a mounting plate and a power device. The gear plate and the bevel gears are mounted inside the chuck housing in a meshed manner. The top of the chuck housing is connected with the mounting plate. The bottom of the chuck housing is supported by the supporting plate. The supporting plate is made of insulating material to insulate the power-on device from the machine tool. Each electric brush assembly is mounted in a groove in the chuck housing. A bottom bearing of each of electric bush assemblies is placed in a groove of the gear plate. The copper bush is mounted on the spindle. An electric brush of each electric brush assembly is pressed against an outer surface of the copper bush. The copper bush, the spindle and the remaining components of the power-on device are ensured to be coaxial.

Preferably, each electric bush assembly includes an electric bush box, an electric bush, a large sliding block and a small sliding block. Each electric brush is mounted inside a corresponding electric brush box and is capable of moving back and forth. A spring is pressed between a rear end of each electric brush and the corresponding electric brush box. Each electric brush box is fixed on an upper surface of a corresponding large sliding block. Each large sliding block is assembled in a groove of the chuck housing. An end of each small sliding block is fixed on a bottom surface of the corresponding large sliding block, and another end of each small sliding block is connected with a bearing and placed in a groove in a surface of the gear plate.

Preferably, the chuck housing includes a housing, a chassis and a retainer. Each bevel gear is fixed in an opening in a side face of the housing through a bearing. The gear plate and the bevel gears are mounted inside the housing in a meshed manner. The retainer is connected with the chassis and supported at an inner circumference of the gear plate. The chassis is connected with the housing.

Preferably, the power device includes a coupler and a motor. An end of the coupler is connected with the motor, and another end of the coupler is connected with one of the bevel gears.

Through the above technical solution, the spindle power-on device proposed by the present disclosure has the following beneficial effects.

The device has the functions of fast power-on and power-off, and can be directly modified on the basis of an original machining spindle, so that the original machining spindle has the function of electric discharge machining, and the device is simple to manufacture, convenient, and fast to install.

The device has the function of automatic compensation of the electric brushes, and the electric bush can be automatically compensated according to the loss of the electric brushes, so that the electric brushes are ensured to be always pressed against the copper bush, and the power-on effect is good.

### BRIEF DESCRIPTION OF THE DRAWINGS

FIG. 1 is a front view of a spindle power-on device proposed by the present disclosure when mounted on the spindle.

FIG. 2 is a front view of a spindle power-on device.

FIG. 3 is a section view of a spindle power-on device.

FIG. 4 is a structural schematic diagram of a gear plate in the present disclosure.

FIG. 5 is a structural schematic diagram of a bevel gear in the present disclosure.

FIG. 6 is a structural schematic diagram of a housing in the present disclosure.

FIG. 7 is a structural schematic diagram of a supporting plate in the present disclosure.

Reference signs: 1, spindle power-on device; 2, power device; 3, spindle; 4, motor; 5, coupler; 6, supporting plate; 7, electric bush assembly; 8, chuck housing; 9, mounting plate; 10, gear plate; 11, retainer; 12, copper bush; 13, electric bush; 14, electric bush box; 15, large sliding block; 16, small sliding block; 17, housing; 18, chassis; and 19, bevel gear.

### DETAILED DESCRIPTION OF THE EMBODIMENTS

The description of the present disclosure is further described in conjunction with the following attached figures, but not regarded to limit the protection scope of the present disclosure.

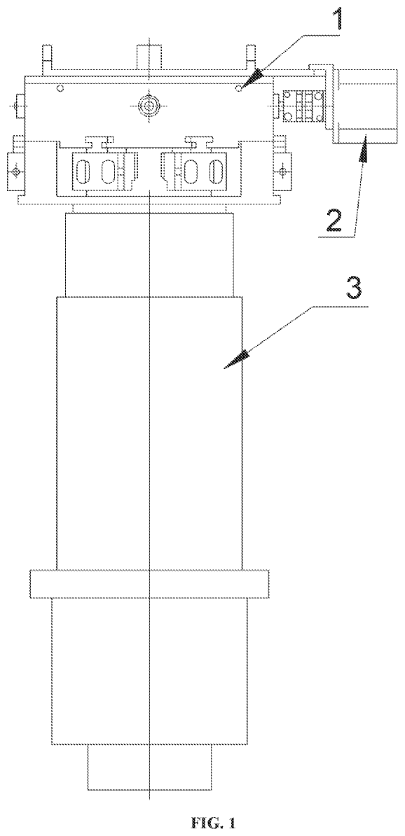

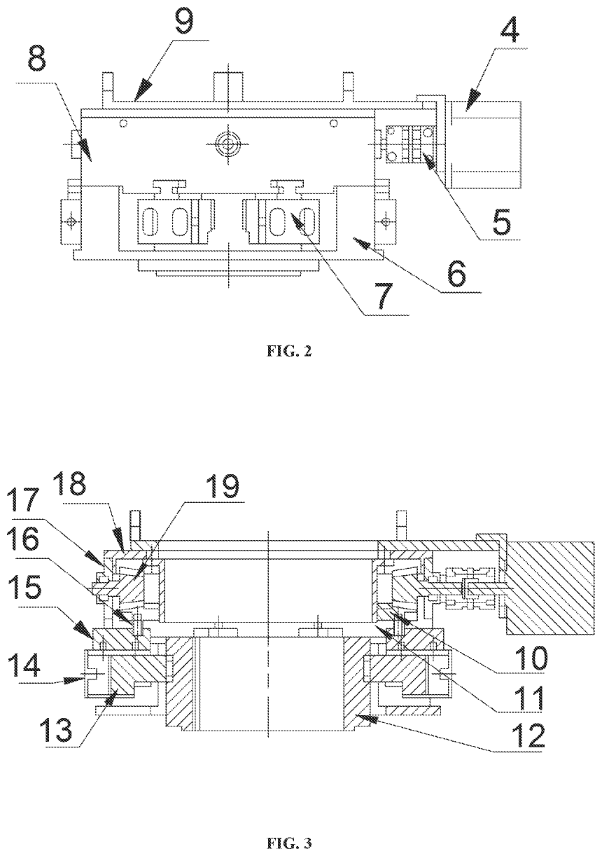

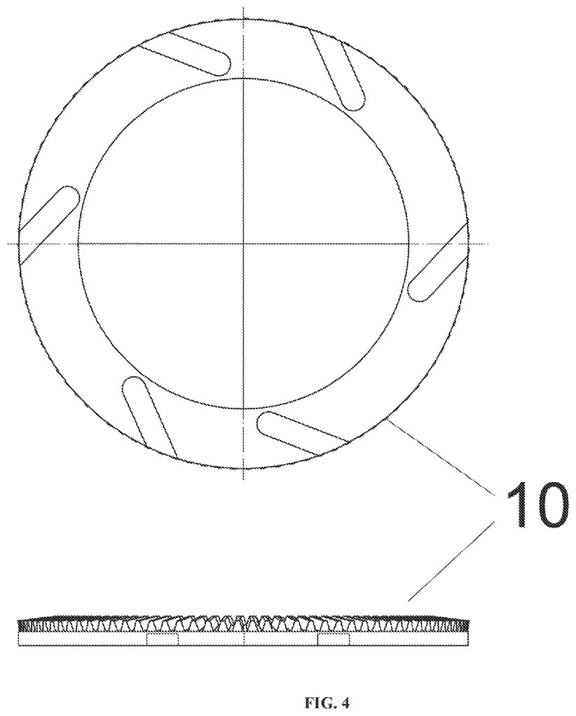

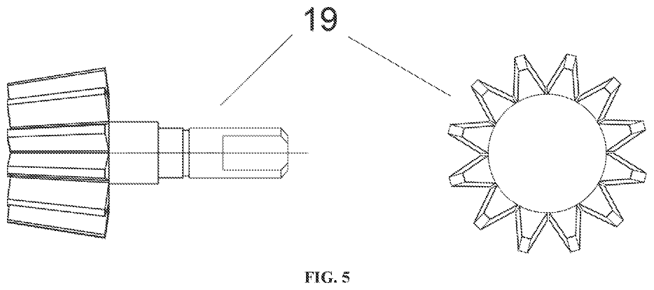

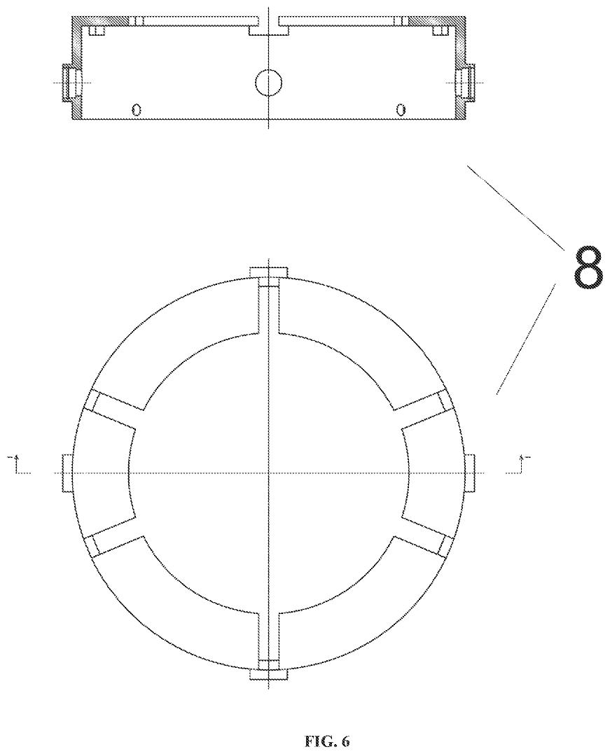

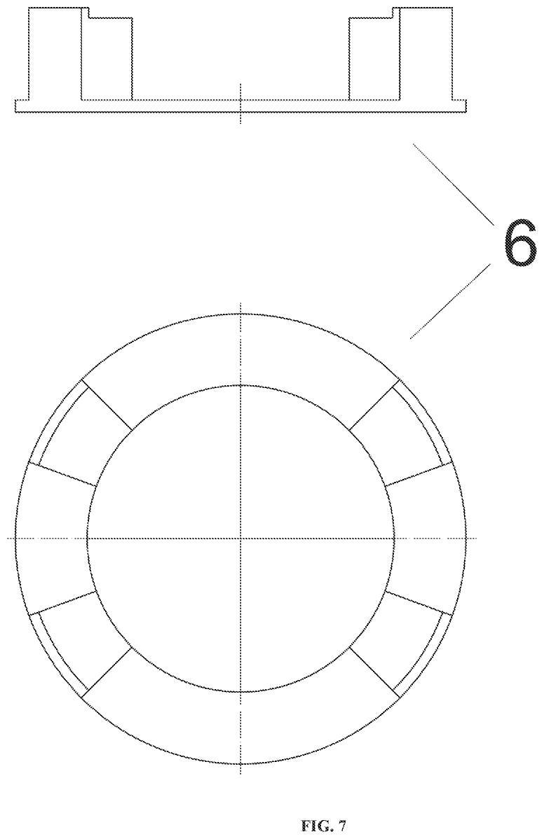

As shown in FIG. 1 to FIG. 3, a spindle power-on device 1 for a mechanical discharge compound machine tool mounted on a spindle 3 is provided, the spindle power-on device 1 includes a copper bush 12, a gear plate 10, bevel gears 19, electric bush assemblies 7, a chuck housing 8, a supporting plate 6, a mounting plate 9 and a power device 2. The gear plate 10 and the bevel gear 19 are mounted inside the chuck housing 8 in a meshed manner. The top of the chuck housing 8 is connected with the mounting plate 9. The bottom of the chuck housing 8 is supported by the supporting plate 6. The supporting plate 6 is made of insulating material to insulate the spindle power-on device 1 from the machine tool. Each electric brush assembly 7 is mounted in a groove in the chuck housing 8. A bottom bearing of each electric bush assembly 7 is placed in a groove of the gear plate 10. The copper bush 12 is mounted on the spindle. An electric brush of each electric brush assembly 7 is pressed against an outer surface of the copper bush 12. The copper bush 12, the spindle 3 and the remaining components of the power-on device 1 are ensured to be coaxial.

Each electric bush assembly 7 includes an electric bush box 14, an electric bush 13, a large sliding block 15 and a small sliding block 16. Each electric brush 13 is mounted inside the corresponding electric brush box 14 and is capable of moving back and forth. A spring is pressed between a rear end of each electric brush 13 and the corresponding electric brush box 14. Each electric brush box 14 is fixed on an upper surface of the corresponding large sliding block 15. Each large sliding block 15 is assembled in a groove of a housing 17. An end of each small sliding block 16 is fixed on a bottom surface of the corresponding large sliding block 15, and another end of each small sliding block 16 is connected with a bearing and placed in a groove in a surface of the gear plate 10.

The chuck housing 8 includes a housing 17, a chassis 18 and a retainer 11. Each bevel gear 19 is fixed in an opening in a side face of the housing 17 through a bearing. The gear plate 10 and the bevel gears 19 are mounted inside the housing 17 in a meshed manner. The retainer 11 is connected with the chassis 18 and supported at an inner circumference of the gear plate 10. The chassis 18 is connected with the housing 17.

The power device 2 includes a coupler 5 and a motor 4. An end of the coupler 5 is connected with the motor 4, and another end of the coupler 5 is connected with one of the bevel gears 19.

The principle of the present disclosure is as follows.

The installation of the device is very simple. The copper bush 12 only needs to be coaxially fixed on a spindle 3 of an original machine tool, and the remaining components of the power-on device 1 of the spindle 3 is sleeved on the copper bush 12 to be fixed on the machine bed, and the electric brushes 13 are ensured to be able to contact with the copper bush 12.

When electric discharge machining is required in normal operation, the motor 4 rotates to drive the bevel gear 19 to rotate. The bevel gear 19 drives the gear plate 10 to rotate in a meshed manner. The gear plate 10 drives each small sliding block 16 in the groove to slide along the groove. Each small sliding block 16 drives the corresponding electric brush assembly 7 to slide back and forth in the groove of the housing 17 through the corresponding large sliding block 15 to realize the contact and separation of the corresponding electric brush 13 with the copper bush 12, so that the power-on and power-off of the spindle 3 are realized.

The present disclosure is not limited to the above specific embodiments, and various changes made by those skilled in the art from the above ideas without creative labor are within the protection scope of the present disclosure.

What is claimed is:

1. A spindle power-on device for a mechanical discharge compound machine tool mounted on a spindle, the spindle power-on device comprising a copper bush, a gear plate, bevel gears, electric bush assemblies, a chuck housing, a supporting plate, a mounting plate and a power device, wherein the gear plate and the bevel gears are mounted inside the chuck housing in a meshed manner, a top of the chuck housing is connected with the mounting plate, a bottom of the chuck housing is supported by the supporting plate, the supporting plate is made of insulating material to insulate the spindle power-on device from the machine tool, each of the electric brush assemblies is mounted in a groove in the chuck housing, a bottom bearing of each electric bush assembly is placed in a groove of the gear plate, the copper bush is mounted on the spindle, an electric brush of each electric brush assembly is pressed against an outer surface of the copper bush, and the copper bush, the spindle and remaining components of the power-on device are ensured to be coaxial.

2. The spindle power-on device for a mechanical discharge compound machine tool according to claim 1, wherein each electric bush assembly comprises an electric bush box, an electric bush, a large sliding block and a small sliding block, each electric brush is mounted inside a corresponding electric brush box and is capable of moving back and forth, a spring is pressed between a rear end of each electric brush and the corresponding electric brush box, each electric brush box is fixed on an upper surface of a corresponding large sliding block, the large sliding block is assembled in a groove of the chuck housing, an end of each small sliding block is fixed on a bottom surface of the corresponding large sliding block, and another end of each small sliding block is connected with a bearing and placed in a groove in a surface of the gear plate.

3. The spindle power-on device for a mechanical discharge compound machine tool according to claim 1, wherein the chuck housing comprises a housing, a chassis and a retainer, each of the bevel gears is fixed in an opening in a side face of the housing through a bearing, the gear plate and the bevel gears are mounted inside the housing in a meshed manner, the retainer is connected with the chassis and supported at an inner circumference of the gear plate, and the chassis is connected with the housing.

4. The spindle power-on device for a mechanical discharge compound machine tool according to claim 1, wherein the power device comprises a coupler and a motor, an end of the coupler is connected with the motor, and another end of the coupler is connected with one of the bevel gears.
